(19) United States
(12) Patent Application Publication
(10) Pub. No.: US 2023/0347351 A1
(43) Pub. Date: Nov. 2, 2023

(54) CLOSURE FOR A SAMPLE TUBE

(71) Applicant: Agency for Science, Technology and Research, Singapore (SG)

(72) Inventor: Cyrus Weijie BEH, Singapore (SG)

(21) Appl. No.: 18/245,267

(22) PCT Filed: Sep. 13, 2021
(86) PCT No.: PCT/SG2021/050553

§ 371 Date: Mar. 14, 2023

(30) Foreign Application Priority Data
Sep. 15, 2020 (SG) 10202009039Q

(51) Int. Cl. B01L 3/00

(52) U.S. Cl. CPC B01L 3/50825; B01L 2200/16; B01L 2300/047; B01L 2300/088; B01L 2300/161

(57) ABSTRACT

A closure for a sample tube comprises a reaction vessel. The reaction vessel comprises: at least one microfluidic mixing channel having an inlet and an outlet; at least one reaction chamber in fluid communication with the inlet and the outlet; an inlet chamber proximate the inlet of the at least one microfluidic mixing channel for introducing a portion of a sample solution from the sample tube into the at least one reaction chamber under hydrostatic pressure; and a diffusion-control feature for limiting egress of fluid from the outlet such that the portion of the sample solution introduced to the at least one reaction chamber is partitioned from the rest of the sample solution.

### BACKGROUND

The need to process large numbers of samples quickly at the point of entry is expected to be a challenge for many countries in the coming months and perhaps years. Typically, the processing of samples is a laborious process that can only be performed inside a diagnostic laboratory setting, where samples collected from subjects are stored in specialized buffers (universal transport medium or UTM), then pipetted into tubes for reaction.

In a conventional process for sample preparation, a swab is used to collect a sample of cells from a subject and then placed into a sample collection tube that contains a buffer. Small glass beads may be contained in the tube to ensure sufficient agitation is achieved. The sample must then be transported to a laboratory, and transferred into smaller tubes with reagents, and processed. The sample handling steps can potentially lead to aerosolization of the sample, and the risk of contagion means that strict sample handling conditions must be enforced.

It would be desirable to provide sample collection devices and assay methods that overcome or alleviate the above difficulties, or that at least provide a useful alternative.

### SUMMARY

The present disclosure relates to a closure for a sample tube, the closure comprising a reaction vessel, the reaction vessel comprising:
at least one microfluidic mixing channel having an inlet and an outlet;
at least one reaction chamber in fluid communication with the inlet and the outlet;
an inlet chamber proximate the inlet of the at least one microfluidic mixing channel for introducing a portion of a sample solution from the sample tube into the at least one reaction chamber under hydrostatic pressure; and
a diffusion-control feature for limiting egress of fluid from the outlet such that the portion of the sample solution introduced to the at least one reaction chamber is partitioned from the rest of the sample solution.

The microfluidic mixing channel may be J-shaped and comprise a short arm in communication with the inlet and a long arm in communication with the outlet.

In some embodiments, the at least one reaction chamber forms a portion of the microfluidic mixing channel intermediate the inlet and the outlet. For example, the reaction chamber may be a U-shaped portion of the at least one microfluidic mixing channel, the U-shaped portion having a larger diameter than that of the remainder of the microfluidic mixing channel. In other embodiments, the at least one reaction chamber may be separate from, and in fluid communication with, the at least one microfluidic channel.

The reaction vessel may comprise one or more lyophilized reagents in the at least one reaction chamber for mixing with the sample solution.

The diffusion control feature may comprise one or more of: an inwardly tapering section of the at least one microfluidic mixing channel at the inlet and/or an inwardly tapering section of the at least one microfluidic mixing channel at the outlet; a tapered section of the inlet chamber that is in communication with the inlet of the microfluidic mixing channel, the tapered section being shaped to allow one or more glass beads in the sample solution to block the inlet; and a hydrophobic section of the microfluidic mixing channel.

In embodiments with a hydrophobic section, the hydrophobic section may extend along the entire length of the microfluidic mixing channel, or only along a part thereof adjacent the outlet. The hydrophobic section may comprise a hydrophobic coating or surface treatment, and/or microtexturing of a surface of the microfluidic mixing channel. In some embodiments, the entirety of the reaction vessel is formed from one or more hydrophobic materials. The hydrophobic section may have a contact angle between about 90 degrees and about 120 degrees.

In some embodiments, the closure comprises a screw thread for attachment to a mating screw thread on the sample tube.

The reaction vessel may be transparent or translucent in at least a region surrounding the at least one reaction chamber.

The inlet may have a diameter Dᵢₙ between about 0.05 mm and 2 mm; and/or the outlet may have a diameter Dₒᵤₜ between about 0.05 mm and 2 mm.

In some embodiments, the inlet chamber has a height between about 6 mm and 20 mm.

In some embodiments, the long arm has a diameter between about 0.1 mm and 2 mm.

In some embodiments, the reaction vessel may be a monolithic structure.

In some embodiments, the inlet and the outlet of the at least one microfluidic mixing channel and the inlet chamber are located in a first part of the closure, and the, or each, reaction chamber is located in a second part of the closure that is attached to the first part. For example, the first part and the second part may be connected via a screw threaded connection. In some embodiments, one part of the screw threaded connection is carried on the first part, and another, mating, part of the screw threaded connection is carried on a collar that fits over the second part and is screwed onto the first part.

The closure may be formed by an additive manufacturing process or an injection moulding process.

The present disclosure also relates to an assay method comprising:
obtaining a sample tube containing a sample solution, the sample tube being sealed by a closure as disclosed herein;
inverting the sample tube such that the sample solution mixes with the one or more lyophilized reagents in the at least one reaction chamber to generate a respective reaction mixture;
optionally, heating and/or cooling the reaction vessel to alter the temperature of the, or each, reaction mixture; and
measuring one or more properties of the, or each, reaction mixture by an optical detection method.

The optical detection method may be colorimetry or fluorometry.

The one or more lyophilized reagents may comprise one or more primer pairs and a DNA polymerase.

### BRIEF DESCRIPTION OF THE DRAWINGS

Some embodiments of a closure for a sample tube, in accordance with present teachings will now be described, by way of non-limiting example only, with reference to the accompanying drawings in which:

FIG. 1 is a schematic cross sectional view through a sample tube assembly comprising a sample tube with a closure according to certain embodiments;

FIG. 2 shows the sample tube assembly of FIG. 1 being inverted to enable a sample solution to enter a reaction vessel of the closure;

FIG. 3 is a cross-sectional view of the closure showing further details of the reaction vessel;

FIGS. 4A and 4B illustrate a mechanism for limiting diffusion in the reaction vessel of FIG. 3; and

FIG. 5 shows modeling of flow of sample solution in a J-shaped microfluidic channel.

### DETAILED DESCRIPTION

This disclosure relates to a point-of-entry (POE), disposable device designed to be used for diagnostic purposes, for example for the detection of COVID-19 infection.

The device is a closure comprising a reaction vessel, that may be in the form of a screw-on cap, and that attaches to a standard sample tube.

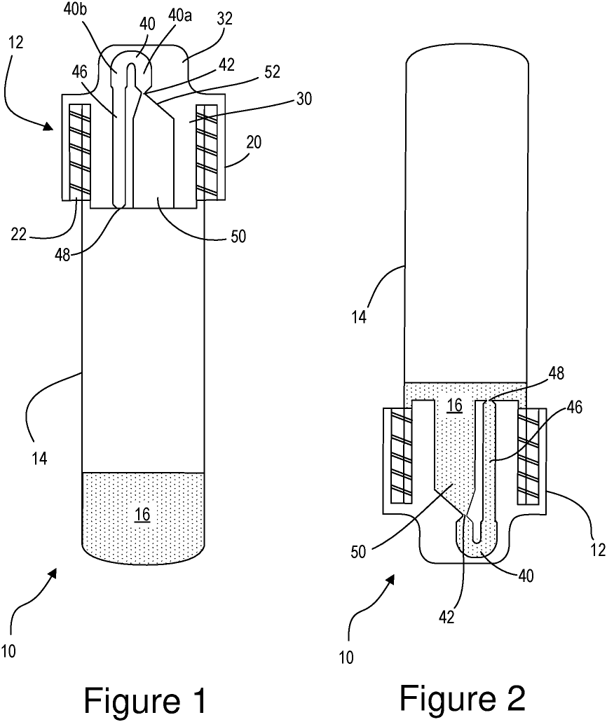

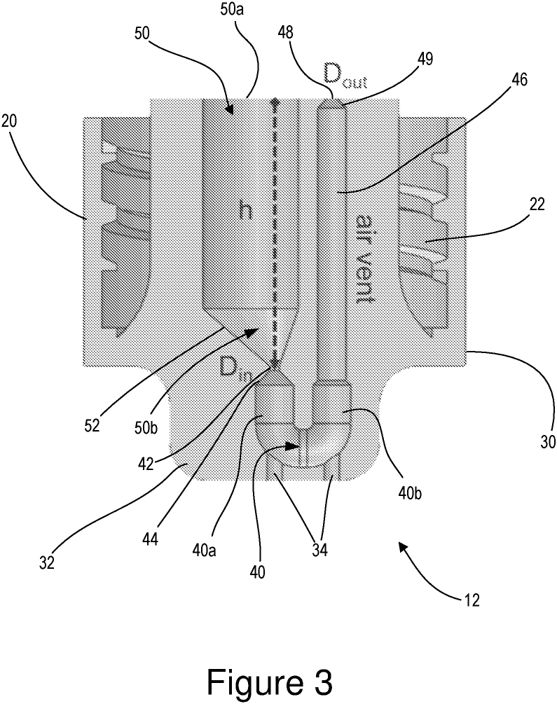

FIGS. 1-3 show one form of a closure 12 that is attachable to a sample tube 14 in a sample tube assembly 10. The closure 12 may be configured as a screw cap, for example, and in this regard may be adapted to attach to any sample tube that has a screw-threaded connection to form a fluid-tight seal, such as a standard nasopharyngeal swab sample-containing collection tube. Other types of connection, such as a snap-fit connection, are also possible.

The sample tube 14 contains a sample solution 16. The sample solution 16 may contain a buffer such as universal transport medium (UTM), into which a swab (not shown) is inserted after a sample is collected from a patient. The sample solution 16 may also contain glass beads (not shown) for use in agitating the sample solution 16. After the swab has been inserted into the sample solution 16, the sample tube 14 is sealed by screwing the closure 12 onto the sample tube 14.

The closure 12 comprises a reaction vessel. The reaction vessel enables mixing of the sample solution 16 with one or more reagents, for example for nucleic acid-based assays. Accordingly, by providing a reaction vessel within the tube closure 12 itself, it is possible to speed up the testing process on-site by a one-tube solution that does not involve the multiple sample handling steps required in conventional testing methods.

The reaction vessel comprises a generally J-shaped microfluidic mixing channel 40, 46 that has an inlet 42 and an outlet 48. The reaction vessel further comprises a reaction chamber 40 that is in fluid communication with the inlet 42 and the outlet 48. The reaction vessel also comprises an inlet chamber 50 that is proximate the inlet 42 of the microfluidic mixing channel 40, 46 for introducing a portion of a sample solution 16 from the sample tube 14 into the microfluidic mixing channel 40, 46 under hydrostatic pressure, for example when the sample tube assembly 10 is inverted as shown in FIG. 2.

The reaction vessel also comprises a diffusion-control feature for limiting egress of fluid from the outlet 48 such that the portion of the sample solution 16 introduced to the reaction chamber 40 is partitioned from the rest of the sample solution. The diffusion-control feature will be described in further detail below, but may comprise, for example, an inwardly tapered section of the microfluidic channel at the inlet 42 and/or an inwardly tapered section of the microfluidic channel at the outlet 48; a tapered section 52 of the inlet chamber 50 that is in communication with the inlet 42, the tapered section 52 being shaped to allow one or more glass beads in the sample solution 16 to block the inlet 42; and a hydrophobic section of the microfluidic mixing channel 40, 46, which may be a coated and/or surface-textured section of the microfluidic mixing channel 40, 46.

By providing a microfluidic mixing channel that has a diffusion-control feature, it is possible to partition a small volume of the sample solution 16 into the reaction chamber 40 of the closure 12, which allows reduction of the reagent consumption per reaction.

On inversion, a small volume of the sample-containing solution 16 flows into the reaction vessel of the closure 12, where it is partitioned from the main tube 14, thus allowing a small reaction volume to be processed. The reaction vessel can contain lyophilized reagents that, when reconstituted with the sample-containing solution 16, will allow for reactions such as nucleic acid amplification assays, including but not limited to PCR, RT-PCR, LAMP, and RT-LAMP to be performed. The configuration of the reaction vessel enables reagents that are required for amplifying nucleic acids in the sample to be separated from the sample solution 16 until they are needed. Further, the typical volume of UTM in a tube 14 is around 3 mL, while most nucleic acid-based detection assays have reaction volumes of only 20-100 microliters. The reaction vessel enables this volume mismatch to be addressed, thus avoiding excessive use of expensive reagents.

The closure 12 comprises a main body 30 with a shroud 20 that surrounds the reaction vessel, and that carries a screw thread 22 for coupling the shroud to a corresponding screw thread of the sample tube 14. A boss 32 extends from the main body 30 of the closure 12. The height of the boss 32 may be increased to enable a greater volume to be defined for the microfluidic mixing channel of the reaction vessel, and/or to increase a hydrostatic head h of the inlet chamber 50 to provide greater driving pressure. The hydrostatic head h may be between about 6 mm and about 20 mm, for example.

The microfluidic mixing channel is continuous and generally J-shaped and has a first, U-shaped, portion 40 and a second, linear, portion 46. The channel comprises a short arm, in this case comprising a first arm 40a of the U-shaped portion 40, that is in communication with the inlet 42. The channel also comprises a long arm that in this case comprises a second arm 40b of the U-shaped portion, and the linear portion 46. The long arm is in communication with the outlet 48 at one end of the linear portion 46. The linear portion 46 acts as an air vent.

In the depicted embodiment, the reaction chamber 40 is U-shaped, but it will be appreciated that other reaction chamber shapes may be adopted. For example, the reaction chamber 40 may be cuboid.

In some embodiments, the U-shaped portion 40 may have a larger diameter than a diameter of the linear portion 46. A reduced diameter of the linear portion (air vent) 46 may be desirable to improve consistency of filling of the microfluidic mixing channel. The narrowing helps to reduce the volume of the vent channel 46, and thus the variation in the total reaction volume (which includes the reaction chamber 40 and the vent channel 46). In some examples, the linear portion 46 has a diameter of between about 0.1 mm and about 2 mm.

One or more lyophilized reagents may be contained in the microfluidic mixing channel for mixing with the sample solution 16. For example, these may be located in the U-shaped portion 40. To this end, the closure 12 may comprise one or more channels 34 for introduction of reagents into the reaction chamber 40. The reagents may be introduced via the channels 34 into the U-shaped portion 40, for example, and the channels 34 may then be sealed by any suitable means. For example, the sealing means may comprise an adhesive seal and/or a cap with a screw-threaded connection that engages with a corresponding screw thread on the boss 32. Where the closure 12 is formed by 3D printing, the same resin that is used to form the remainder of the closure 12 can be used to seal the channels 34.

The reagents may comprise one or more primer pairs and a DNA polymerase, for example.

Introduction of reagents into the U-shaped portion 40 may be done at the time of manufacture of the closure 12. Alternatively, the closure 12 may be provided without reagents and these can be added at the point of entry prior to applying the closure 12 to the sample tube 14.

In the Figures, a single microfluidic channel and single reaction chamber are depicted as part of the closure 12. However, it will be appreciated that in some embodiments, multiple microfluidic channels and/or multiple reaction chambers may be present. For example, in some embodiments the closure 12 may comprise two or more reaction chambers 40, each having an inlet that is in communication with a respective outlet of the inlet chamber 50. Each reaction chamber 40 may be in communication with a respective vent channel 46, such that in use, a respective reaction mixture is formed in respective reaction chamber 40/vent channel 46 and segregated from the remainder of the sample solution 16.

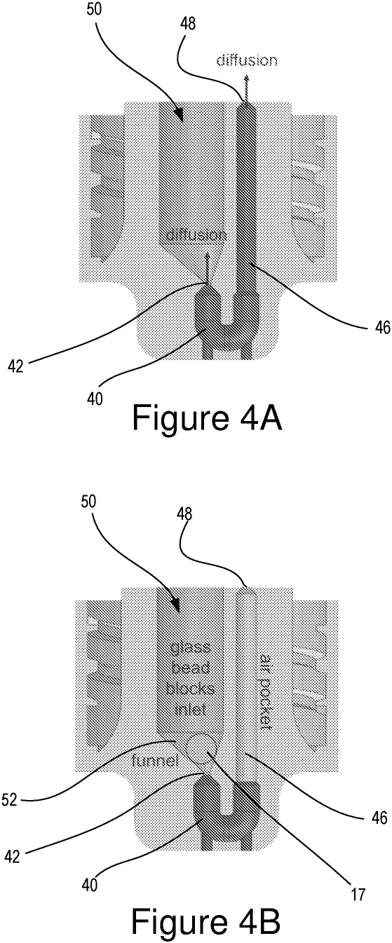

Mass transport out of the reaction vessel can occur due to convection or diffusion. Convection stops once the hydrostatic head is removed (e.g. when the reaction vessel is fully filled), or is no longer large enough to drive the solution forward. In the former case, the fully filled reaction vessel is then subject to diffusion as depicted schematically in FIG. 4A. Because the solution at inlet 42 and outlet 48 is contiguous with the rest of the sample tube, the reagent-containing reaction mixture in U-shaped portion 40 and linear portion 46 will eventually diffuse out of the reaction vessel, back into the sample solution (e.g., in inlet chamber 50).

To limit the rate of diffusion out of the microfluidic channel 40, 46, one or more diffusion control features can be provided at the inlet 42 and/or the outlet 48.

For example, a reduced diameter portion at the inlet 42 may serve as a diffusion control feature. The reduced diameter portion may comprise a tapered portion 44 of the microfluidic channel at the inlet 42. The microfluidic channel may therefore taper inwardly from the first arm 40a of the U-shaped portion 40 towards the inlet 42, such that the inlet 42 has a diameter Dᵢₙ that is less than a diameter of the first arm 40a of the U-shaped portion 40. In some examples, the diameter Dᵢₙ is between about 0.05 mm and 2 mm.

In another example of a diffusion control feature, a reduced diameter portion may be provided at the outlet 48 of the microfluidic channel. The reduced diameter portion at the outlet 48 may comprise a tapered portion 49. The microfluidic channel may therefore taper inwardly from the linear portion 46 towards the outlet 48, such that the outlet 48 has a diameter Dₒᵤₜ that is less than a diameter of the linear portion 46. Dₒᵤₜ may be between about 0.05 mm and 2 mm.

In another example of a diffusion control feature at the outlet end 48, since the in-flowing sample solution 16 interacts with the channel walls, it is possible to design the channel walls such that the wall/solution interaction is slightly unfavorable (i.e., slightly hydrophobic). Coupled with the surface tension at the outlet 48, this will result in an air pocket, which prevents direct contact between the sample solution 16 in the tube 14 and the reagent-containing solution in the microfluidic channel.

At least a section of the channel walls adjacent the outlet 48, or the entire length of the channel walls (e.g. of linear section 46) or even the entire closure 12, may be made at least partly hydrophobic. The hydrophobicity may be imparted by microtexturing and/or by application of a surface treatment. For example, microtexturing may be applied in an injection molding process, in which the channel surface is deliberately roughened. In another example, microtexturing may be applied by chemical etching. In some examples, the hydrophobicity can also be provided to the entire closure 12 by appropriate selection of the material used to fabricate the closure 12. In further examples, surface treatment can be applied to at least the microfluidic channel by vapor deposition of chemicals such as fluorinated silanes.

In some embodiments, the contact angle of the section of the channel walls adjacent the outlet may be in the range from about 90 degrees to 120 degrees. This ensures reliable formation of an air bubble. Where the entire length of the wall of channel 46 is made hydrophobic, this also ensures effective infilling. It will be appreciated that in some embodiments where only the section adjacent outlet 48 is hydrophobic, other ranges of contact angles may be possible, e.g. 120 degrees to 150 degrees, or 150 degrees to 180 degrees. It will also be appreciated that it may still be possible for an air bubble to form where the contact angle is less than 90 degrees, but that it may not do so reliably.

The inlet chamber 50 of the reaction vessel is arranged generally parallel to the long arm 46 of the microfluidic channel and has an inlet 50a for receiving sample fluid 16, and an outlet generally indicated at 50b and in communication with the inlet 42 of the microfluidic channel, in this case with first arm 40a of the U-shaped portion 40. The inlet chamber 50 provides a hydrostatic head h for driving fluid into the microfluidic channel, and may comprise a generally cylindrical section extending from the inlet 50a towards an inwardly tapering section 52 that ends at the outlet 50b.

The inwardly tapering section 52 may provide a further example of a diffusion control feature at the inlet 42. As shown in FIG. 4B, if glass beads 17 (for agitation) are present in the sample solution 16, the inwardly tapering section 52 provides a funnel into which the glass beads 17 will fall when the sample tube assembly 10 is inverted. Because the glass beads 17 are denser than the aqueous solution 16, they will fall into this funnel 52 to block the inlet 42. The shape of the funnel 52 may be designed so that some variation in the bead size can be tolerated.

The inlet chamber 50 and linear portion 46 of the microfluidic channel may reside in the main body 30 of the closure 12, while the reaction chamber 40 may reside in the boss 32.

In some embodiments, the closure 12 may be transparent or translucent in at least a region surrounding the reaction chamber. For example, the transparent region may encompass just the U-shaped portion 40, or may also encompass the linear portion 46. By providing transparency or translucency in at least the reaction chamber of the closure 12, the sample tube assembly 10 can be directly used in assays that use optical detection methods, such as fluorimetry or colorimetry.

The closure 12 may be a monolithic structure, and may be formed by, for example, an additive manufacturing process or an injection moulding process.

In some embodiments, the closure 12 may be formed from multiple parts, which may improve ease of manufacture and/or ease of loading reagents. For example, the closure 12 may be formed such that the inlet 42 and the outlet 48 of the at least one microfluidic mixing channel and the inlet chamber are located in a first part of the closure, and the, or each, reaction chamber is located in a second part of the closure that is attached (e.g., removably attached) to the first part. This enables reagents to be loaded into the reaction chamber or reaction chambers in the second part, and then the first part can be assembled together with the second part so that each reaction chamber is in communication with the outlet of the inlet chamber 50, and an inlet of a respective vent channel 46. Each reaction chamber may, but need not be, U-shaped.

The first part 30 and the second part 32 may be joined by any suitable means. In some embodiments, the first part may be connected to the second part via a connector that enables a fluid-tight seal between the first and second parts. For example, the connector may be a collar (e.g. an annular collar) that fits over the second part to engage with at least a portion thereof, and is also connectable to the first part. In some embodiments the second part may have a flange or skirt that engages with a lower surface of the collar, and the collar may have a sidewall that can form a connection with the first part, for example via a screw-threaded or snap-fit connection.

In some examples, the first part may correspond generally to the main body 30, and the second part may correspond generally to the boss 32.

By inserting the inverted tube assembly 10 into a customized heating element, reactions such as isothermal PCR can be performed. The thermal mass of the closure 12 can also be further reduced by optimizing the geometry to allow for effective heating and cooling, so as to enable thermal cycling. For example, the sidewalls of closure 12 surrounding the reaction chamber 40 and vent channel 46 may be designed with a thickness that optimizes heat transfer to the reaction mixture in reaction chamber 40/vent channel 46. The reaction chamber 40 of closure 12 extends away from the UTM tube body 14, which allows the reaction to be easily accessible for heating, and because the device is clear in at least the region surrounding reaction chamber 40, it is also amenable to detection by optical means (colorimetric or fluorescence).

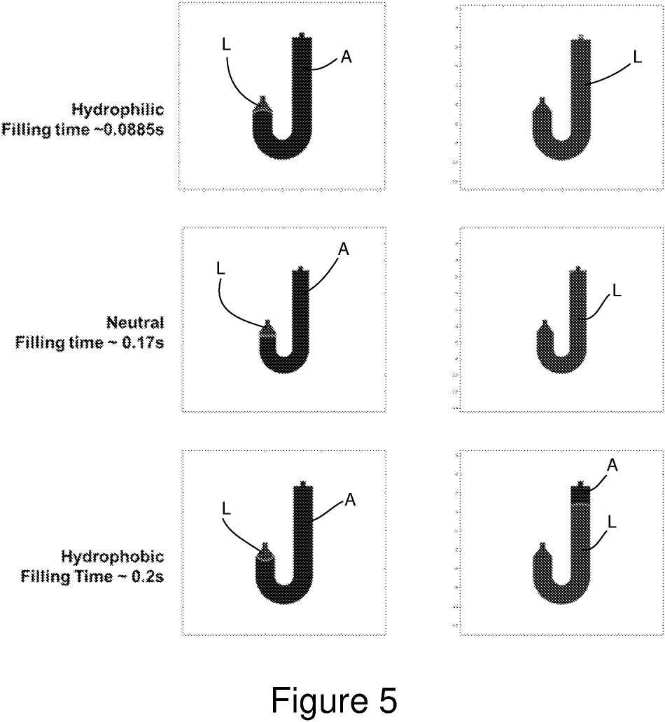

Turning now to FIG. 5, results of a simulation that was performed to study the effects of the wall/solution interaction are shown. A computational model of a J-shaped region (akin to the structure of microfluidic channel 40, 46) was constructed, and the contact angle changed from wetted, to neutral, to repulsive. Using this model, it was determined that hydrophilic walls will draw the solution in, aiding the loading process, and speeding it up. Loading was completed within 90 ms in the model, compared with 170 ms when the contact angle was 90 degrees, i.e. no additional contribution to the loading process from the wall/solution interaction. Lastly, when the wall is made hydrophobic, the loading time was further slowed down to 200 ms. However, it is important to note that the air pocket is never fully removed in this case, even after the model was run to 1 second. In other words, the presence of this additional repulsive force was sufficient to create an air pocket that can isolate the outlet 48 from the rest of the sample tube 14.

It is worth noting at this point that in order to ease the computational needs, the model geometry is somewhat simplified. In particular, the air vent region was kept at the same diameter as the U-shaped portion. In practice, the air vent volume may be reduced, so that the total reaction volume can be kept more consistent (the air pocket may differ in size depending on the particular device).

This reduced diameter will in turn increase the resistance to the flow of liquids and, to a negligible extent, air flow. On the other hand, capillary effects become more pronounced, so hydrophilic or hydrophobic effects will dominate at the air vent. By making the walls slightly hydrophobic, and the air vent diameter smaller, it can then be ensured that flow into the air vent region 46 of the device 12 is prohibited.

FIG. 5 shows modelling of the flow of sample solution into the J-shape channel. In each of the panels of FIG. 5, “L” indicates liquid while “A” indicates air. The left hand panels show the channel at the beginning of the simulated filling process while the right hand panels show the channel at the end of the simulated filling process. As the walls become more hydrophobic, they begin to resist the infilling of the chambers. By controlling the channel dimensions and wall materials, it can thus be ensured that the filling can be performed in a predictable manner.

Embodiments of the present disclosure are designed to allow processing of samples in a single, enclosed tube 10 without additional pipetting steps, which is of great importance when risk of contagion is present. While the present disclosure describes only nucleic acid amplification, the device described herein can be used in different assays that require the partition of a sample volume into a separate chamber, including detection by enzymatic cleavage, ELISA, etc. It may also be possible to repeat the test, or perform different tests using the same sample solution 16, by replacing the closure 12 with a fresh one, and re-inverting the assembly 10 with the new closure 12, although this should only be performed if appropriate safety precautions are taken.

Embodiments may have one or more of the following features or advantages:
Allows automatic handling of fluid to sample a small volume in a single enclosed tube;
Uses a combination of physical properties (surface tension, capillary forces, hydrostatic pressure) to control the speed and extent of infilling of the device, so as to yield reproducible reaction volume;
May contain reagents that are lyophilized or otherwise preserved, and that are reconstituted by the in-flowing sample-containing solution;
Uses glass beads that are already present in UTM tubes for agitation to act as a valve to minimize diffusion of reagents out of the reaction chamber;
Contains a detection region where quick readout of assay can be accomplished by changes in either color or fluorescence intensity;
Partitioning of a small volume of the sample solution into the reaction chamber, which allows us to reduce the reagent consumption per reaction.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A closure for a sample tube, the closure comprising a reaction vessel, the reaction vessel comprising:
at least one microfluidic mixing channel having an inlet and an outlet;
at least one reaction chamber in fluid communication with the inlet and the outlet;
an inlet chamber proximate the inlet of the at least one microfluidic mixing channel for introducing a portion of a sample solution from the sample tube into the at least one reaction chamber under hydrostatic pressure; and
a diffusion-control feature for limiting egress of fluid from the outlet such that the portion of the sample solution introduced to the at least one reaction chamber is partitioned from the rest of the sample solution.

2. A closure according to claim 1, wherein the at least one reaction chamber forms a portion of the microfluidic channel intermediate the inlet and the outlet.

3. A closure according to claim 1, wherein the microfluidic mixing channel is J-shaped and comprises a short arm in communication with the inlet and a long arm in communication with the outlet.

4. A closure according to claim 2, wherein the at least one reaction chamber is a U-shaped portion of the microfluidic channel, the U-shaped portion having a larger diameter than that of the remainder of the microfluidic channel.

5. A closure according to claim 1, wherein the at least one reaction chamber is separate from, and in fluid communication with, the at least one microfluidic channel.

6. A closure according to claim 1, comprising one or more lyophilized reagents in the at least one reaction chamber for mixing with the sample solution.

7. A closure according to claim 1, wherein the diffusion control feature comprises an inwardly tapering portion of the at least one microfluidic channel at the inlet, and/or an inwardly tapering portion of the at least one microfluidic channel at the outlet.

8. A closure according to claim 1, wherein the diffusion control feature comprises a tapered section of the inlet chamber that is in communication with the inlet of the at least one microfluidic mixing channel, the tapered section being shaped to allow one or more glass beads in the sample solution to block the inlet.

9. A closure according to claim 1, wherein the diffusion control feature comprises a hydrophobic section of the at least one microfluidic mixing channel.

10. A closure according to claim 9, wherein the hydrophobic section extends along the entire length of the at least one microfluidic mixing channel.

11. A closure according to claim 9, wherein the hydrophobic section is adjacent the outlet.

12. A closure according to claim 9, wherein the hydrophobic section comprises a hydrophobic coating or surface treatment, and/or microtexturing of a surface of the at least one microfluidic mixing channel.

13. A closure according to claim 9, wherein the entirety of the reaction vessel is formed from one or more hydrophobic materials.

14. A closure according to claim 9, wherein the hydrophobic section has a contact angle between about 90 degrees and about 120 degrees.

15. A closure according to any claim 1, wherein the reaction vessel is transparent or translucent in at least a region surrounding the at least one reaction chamber.

16. A closure according to claim 1, wherein the closure is a monolithic structure.

17. A closure according to claim 1, wherein the inlet and the outlet of the at least one microfluidic mixing channel and the inlet chamber are located in a first part of the closure, and the, or each, reaction chamber is located in a second part of the closure that is attached to the first part.

18. An assay method comprising:
obtaining a sample tube containing a sample solution, the sample tube being sealed by a closure according to claim 6;
inverting the sample tube such that the sample solution mixes with the one or more lyophilized reagents in the, or each, reaction chamber to generate a respective reaction mixture;
optionally, heating and/or cooling the reaction vessel to alter a temperature of the, or each, reaction mixture; and
measuring one or more properties of the, or each, reaction mixture by an optical detection method.

19. An assay method according to claim 18, wherein the optical detection method is colorimetry or fluorometry.

20. An assay method according to claim 18, wherein the one or more lyophilized reagents comprise one or more primer pairs and a DNA polymerase.
